(19) United States
(12) Patent Application Publication
(10) Pub. No.: US 2025/0306864 A1
(43) Pub. Date: Oct. 2, 2025

(54) PROGRAMMING SYSTEM FOR FORM DESIGN AND APPLICATIONS

(71) Applicant: Xiaolong Tang, Louisville, KY (US)

(72) Inventor: Xiaolong Tang, Louisville, KY (US)

(21) Appl. No.: 19/089,827

(22) Filed: Mar. 25, 2025

Related U.S. Application Data
(60) Provisional application No. 63/570,207, filed on Mar. 26, 2024.

(51) Int. Cl. G06F 8/30

(52) U.S. Cl. CPC G06F 8/31

(57) ABSTRACT

A programming language designed for building rich form applications, including creating various forms. The language comprises modular components that streamline the definition of questions, form structures, data flow logic, and functions for forms. The language supports simple questions and compound questions, which can be object-like or array-like. Forms defined in this language are flexible, with customizable styles and layouts adaptable to various user interfaces. Data flow rules automate runtime form state changes, while form functions enable powerful runtime computation on form state and responses, thereby allowing automatic response analysis and multi-form workflow. The language provides common, modular, reusable, reliable function units for the developers to build form applications. The language promotes form portability across vendors and applications, enabling a growing set of form applications that users can freely switch between without losing their form data and fostering a community for form sharing and form advancement by all form stakeholders.

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### BACKGROUND OF THE INVENTION

### 1) Field of the Invention

The invention relates to the field of form creation systems and more specifically to the programming language and how it is tied to specific applications and/or vendors.

### 2) Description of Related Art

Existing form creation systems are often inflexible and tied to specific applications or vendors; form representations are highly confined into one application/vendor. As such, form portability is very limited; Forms created in one system often can't be used in another. This lack of portability creates several challenges:
(1) High development cost: Each vendor needs to rebuild core form functionality; the reuse of the software stack for building form applications among applications/vendors is nothing or little.
(2) Lack of form standardization: A standard about how to represent form data and its meaning is poorly addressed. One observation is that the relationship between questions can be exploited for efficient reuse and effective analysis for form applications. In one case, the questions that are thematically linked or have a hierarchical relationship can be captured with a family of questions. A “family of questions” approach makes it easier to create new forms by reusing and extending existing question components; it also provides the insight into the form structure. In another case, when a question inherits the properties, logic, or validation rules from another question, their inheritance can be formalized. With inheritance, forms can be partially generated based on a set of defined rules and relationships. Another observation is that the operations between forms can be exploited as well. For example, by comparing two forms, it is possible to determine the compatibility between them, thus hindering data merging or the use of one form in place of another.
(3) Lack of a cross-vendor community: The lack of form portability between applications and vendors hinders the creation of a collaborative community focusing on improving form technology. Such a community could accelerate innovation, reduce development costs, and better address the needs of form users. This invention provides a foundation for portable forms, paving the way for a future where form creation is more efficient and addresses ever-evolving challenges. These challenges include dynamic question types, complex data flows, automated evaluation, optimization tools, powerful reporting, flexible generation methods, AI integration, and streamlined workflows.

### BRIEF SUMMARY OF THE INVENTION

The instant invention in one form is directed to introduce a programming language specifically designed for building rich form applications, including creating various forms. The language comprises modular components that streamline the definition of questions, form structures, data flow logic, and functions for forms. It supports both simple questions (requiring single inputs) and compound questions, which can be object-like (expecting structured record inputs) or array-like (accepting multiple records). Forms defined in this language are flexible, with customizable styles and layouts adaptable to various user interfaces via a form translator. Data flow rules automate runtime form state changes, while form functions enable powerful runtime computation on form state and responses, thereby allowing automatic response analysis and multi-form workflows. This language lays a solid foundation for a rich ecosystem of form applications, including form design, persistence, interpretation/compilation, optimization, response evaluation, workflow management, publication, and reporting. It provides a set of common, modular, reusable, reliable function units for the developers to build form applications. It also promotes the form portability across vendors and applications, enabling a growing set of form applications that users can freely switch between without losing their form data.

According to an aspect of the present disclosure, a programming language for building rich form applications is provided. The programming language includes creating forms that are portable, wherein form representations are self-contained, including all necessary data and logic for execution, and independent of specifications. The forms are designed to foster a community of form respondents, form designers, form application developers, and third-party integrators across different vendors and applications, promoting collaboration and innovation in form design.

The programming language comprises modular components for streamlining the definition of the static structure and runtime behavior of forms. These components include a question definition module that provides an extensible object-oriented specification language for defining questions, a form definition module that provides an extensible declarative specification language for defining forms, a data flow module that provides a rule-based specification language for defining runtime state changes of forms, and a function definition module that provides a functional programming language for building complex calculations on form states and form responses.

According to other aspects of the present disclosure, the programming language may include one or more of the following features. The programming language may comprise a set of reusable components, which operate on the programming language to build form applications. These components may include portable representations for questions, forms, data flows, and functions, as well as lexers and parsers for questions, forms, data flows, and functions.

The programming language may further comprise an extensible, modular, translator-based pipeline for generating target form presentations. This pipeline may take portable form representations as input and produce target form representations as output, utilize the reusable components to efficiently build the target form presentations, and generate various types of forms including inline forms, web forms, and single-page applications for multi-form workflow presentations.

The programming language may also include an architecture for defining rules to evaluate form responses and trigger custom actions based on evaluation results. This architecture may utilize the reusable components to interpret questions, forms, and functions, and define two types of workflows: form actions and form flows.

Additionally, the programming language may comprise an architecture for executing the workflows, an architecture for publishing workflows, and provide a solid foundation for rich form applications including form design, persistence, interpretation and compilation, optimization, response evaluation, workflow management and publication, and reporting.

The programming language may set common, modular, reusable, and reliable function units for developers to build form applications, promote form portability across vendors and applications, and enable users to switch between applications without losing form data.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 is the structure of the language;

FIG. 2 is the question module of the programming language;

FIG. 3 is a group question defined in the programming language;

FIG. 4 is a table question defined in the programming language;

FIG. 5 (A-D) is a form created using the programming language;

FIG. 6 (A-B) is the data flow module of the programming language;

FIG. 7 is the form function module of the programming language;

FIG. 8 is a form design system based on the programming language;

FIG. 9 is a form translator system;

FIG. 10 is a system for defining the automation tasks for the forms;

FIG. 11 is a system that automatically evaluates the form responses based on the form automation tasks;

FIG. 12 is a form publication system;

FIG. 13 is an automation system for managing and automating form routine tasks;

FIG. 14 is a cloud computing environment that is suitable for hosting service as characterized in the programming language; and

FIG. 15 is a general-purpose computer system designed to execute a wide range of software applications.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The terms “programming language” and “language” are used interchangeably to mean a programming structure to the instant invention.

The present disclosure relates to a programming language for building rich form applications. This programming language may be designed to create forms that are portable and independent of specific applications or vendors. The language may utilize modular components that streamline the definition of questions, structures, data flow logic, and functions for forms.

In some cases, the programming language may support the creation of forms that are self-contained, including all necessary data and logic for execution. This approach may promote form portability across different vendors and applications, potentially enabling users to switch between applications without losing their form data.

The programming language may be designed to foster a community of form respondents, form designers, form application developers, and third-party integrators across different vendors and applications. This community-oriented approach may promote collaboration and innovation in form design.

In some implementations, the programming language may comprise various modules for defining different aspects of forms. These modules may include components for question definition, form definition, data flow specification, and function definition. The language may also include a set of reusable components for building form applications and an extensible, modular, translator-based pipeline for generating target form presentations.

The programming language may provide a foundation for a range of form applications, including form design, persistence, interpretation/compilation, optimization, response evaluation, workflow management, publication, and reporting. This approach may offer developers a set of common, modular, reusable, and reliable function units for building form applications.

The programming language may include a question definition module that provides an extensible object-oriented specification language for defining questions. This module may allow for the creation of various types of questions, including simple questions that require single inputs and compound questions that can be object-like or array-like.

In some cases, the question definition module may treat each question as an object with a set of attributes. These attributes may include, but are not limited to, text, labels, titles, and input validation rules. The module may support multi-language capabilities for text and labels, allowing questions to be presented in different languages based on user preferences or system settings.

For example, a simple question object may be defined with attributes such as:
1. Question text (in multiple languages);
2. Input type (e.g., text, number, date);
3. Validation rules (e.g., minimum value, maximum value, regular expression patterns);
4. Custom attributes for extensibility.

In some implementations, the question definition module may allow for the creation of compound questions. These compound questions may be object-like, expecting structured record inputs, or array-like, accepting multiple records. For instance, an object-like compound question might represent an address with sub-questions for street, city, state, and zip code. An array-like compound question could be used to collect multiple phone numbers from a respondent.

The extensible nature of the specification language may allow developers to add custom attributes to questions as needed. This flexibility may enable the adaptation of questions to specific use cases or industries without modifying the core language structure.

In some cases, the question definition module may support inheritance, allowing new questions to be derived from existing ones. This feature may promote reusability and consistency across forms. For example, a base “numeric input” question type could be extended to create specialized versions for currency inputs or percentage inputs, inheriting common attributes and validation rules while adding specific functionality.

The multi-language support provided by the question definition module may extend beyond just question text and labels. It may also apply to error messages, help text, and other textual elements associated with questions. This comprehensive language support may facilitate the creation of truly multilingual forms that can be easily localized for different regions or user groups.

The programming language may include a form definition module that provides an extensible declarative specification language for defining forms. This module may allow for the creation of comprehensive form structures that incorporate various elements and properties.

In some cases, the form definition module defines the structure and layout of a form through a declarative approach. This includes defining question declarations and form layout specifications. A question declaration introduces a defined question into a form, enabling the referencing of the question's text, input type, data binding, validation rules, and other properties. The form layout specification defines the hierarchical structure of a form's user interface. This hierarchy is typically defined in terms of abstract user interface elements. All user interface elements may include custom properties such as style specifications for layout purposes. For example, in one implementation, a grid structure is utilized to define the form's layout. The grid structure comprises a top-level container element containing multiple rows. Each row, in turn, comprises multiple columns. Each column, in turn, may comprise one or more cells. A cell element may contain a leaf element or a nested top-level container element. Examples of leaf elements include question labels and inputs, field labels and inputs for group questions, table elements, child elements of tables, and column labels and inputs in tables. When rendering the user interface of a form, a layout algorithm interprets these user interface elements and their hierarchical relationships. For example, an algorithm can translate the grid structure into a corresponding grid structure in a target technology, such as the Bootstrap grid system in HTML. More sophisticated layout algorithms can be implemented to accommodate specific design requirements or target platforms. In some cases, the form definition module may support multi-language capabilities for text and labels within forms. This feature may enable the creation of forms that can be presented in different languages based on user preferences or system settings. The multi-language support may extend to form titles, section headers, instructions, and other textual elements within the form structure.

The extensible nature of the specification language may allow for additional attributes and elements to be added to the form definition as needed. This flexibility may enable developers to incorporate custom properties or metadata into their form definitions without modifying the core language structure.

In some cases, the form definition module may support conditional rendering of form sections or questions based on user responses or other criteria. This feature may allow for the creation of dynamic forms that adapt to user input or context. The form definition module may also provide mechanisms for defining form-level validation rules, submission behavior, and other form-wide properties. These features may complement the question-level attributes defined in the question definition module, allowing for comprehensive control over form behavior and functionality.

The programming language may include a data flow module that provides a rule-based specification language for defining runtime state changes of forms. This module may enable dynamic behaviors of forms as respondents interact with them, allowing for conditional branching, automatic value assignment, and input validation. The data flow module may utilize a rule-based approach where each rule comprises an optional precondition and a postcondition. This structure may allow for flexible and powerful control over form behavior based on user input and form state. The conditional branching capability of the data flow module may enable forms to adapt their structure or content based on user responses.

Automatic value assignment may be another feature supported by the data flow module. This capability may allow for the automatic population of form fields based on user input or other form states.

The data flow module may also support input validation rules. These rules may help ensure that user inputs meet specific criteria before form submission.

In some implementations, the data flow module may support more complex logic combining multiple conditions and actions.

The rule-based specification language of the data flow module may be designed to be both human-readable and machine-interpretable. This approach may facilitate easier development and maintenance of complex form logic while also allowing for efficient processing by form rendering engines.

In some cases, the data flow module may support the definition of custom functions or macros that can be reused across multiple rules. This feature may promote code reuse and help maintain consistency in form behavior across different sections or even different forms within the same application.

The data flow module may also provide mechanisms for handling edge cases and error conditions. For example, rules may be defined to handle situations where expected data is missing or invalid, ensuring that the form remains functional and user-friendly even in unexpected scenarios.

The programming language may include a function definition module that provides a functional programming language for building complex calculations on form states and form responses. This module may enable advanced form state changes and automate form tasks, allowing for sophisticated form behaviors and data processing capabilities. The function definition module may support first-class functions, which means that functions can be treated as values and assigned to variables, passed as arguments to other functions, or returned as results from functions. This capability may allow for flexible and dynamic function composition within forms.

The function definition module may also support higher-order functions, which are functions that can take other functions as arguments or return functions as results. This feature may enable powerful abstractions and reusable code patterns within form logic. The function definition module may support recursion, allowing functions to call themselves. This capability may be useful for implementing complex algorithms or traversing hierarchical form structures.

The function definition module may enable advanced form state changes through complex calculations on form states and responses. This function may calculate a subtotal from line items, apply a tax rate, and update relevant form fields with the results.

The function definition module may also facilitate the automation of form tasks. For instance, a function might be defined to handle auto-redirection in multi-form workflows. The function definition module may support custom event and action triggers based on form responses. This function may handle form submission, triggering different actions based on the user's contact preference and form validity. The function definition module may also provide capabilities for data validation and transformation. For instance, a function might be defined to standardize and validate phone numbers. This function may remove non-digit characters from a phone number input, check if it matches a valid format, and return a standardized version if valid.

By supporting first-class functions, higher-order functions, and recursion, the function definition module may provide a powerful and flexible toolset for implementing complex form logic and behaviors. These capabilities may enable form developers to create sophisticated, dynamic, and responsive forms that can adapt to user inputs and automate various tasks within the form workflow.

The programming language may include a set of reusable components that operate on the language to build form applications. These components may provide a foundation for creating, processing, and manipulating various aspects of forms.

In some cases, the reusable components may include portable representations for questions, forms, data flows, and functions. These portable representations may allow for the storage and transfer of form-related information in a standardized format, independent of specific applications or platforms.

The programming language may include a question lexer and parser. This component may be responsible for serializing and deserializing question representations in non-volatile memory. Additionally, the question lexer and parser may generate question abstract syntax trees in volatile memory. A form lexer and parser may also be included as a reusable component. This component may handle the serialization and deserialization of form representations in non-volatile memory. The form lexer and parser may also generate form abstract syntax trees in volatile memory. The programming language may include a data flow lexer and parser as another reusable component. This component may be responsible for serializing and deserializing data flow representations in non-volatile memory. Additionally, the data flow lexer and parser may generate data flow abstract syntax trees in volatile memory. A function lexer and parser may also be included as a reusable component. This component may handle the serialization and deserialization of function representations in non-volatile memory. The function lexer and parser may also generate function abstract syntax trees in volatile memory.

In some cases, these reusable components may be used together to build comprehensive form applications. The reusable nature of these components may allow developers to easily incorporate form processing capabilities into their applications without needing to implement the underlying parsing and representation logic themselves. This approach may promote consistency and efficiency in form application development across different platforms and use cases.

The programming language may include an extensible, modular, translator-based pipeline for generating target form presentations. This pipeline may be designed to take portable form representations as input and produce target form representations as output, which respondents can interact with. The pipeline may utilize the reusable components of the programming language to efficiently build the target form presentations. These components may include parsers and abstract syntax trees for questions, forms, data flows, and functions. The pipeline may be capable of generating various types of form presentations to suit different use cases and deployment scenarios. For example, the pipeline may generate inline forms for embedding form presentations into third-party applications. These inline forms may contain responses or may be blank, depending on the specific requirements of the application. The pipeline may generate web forms for full-fledged, one-page form presentations. These web forms may optionally leverage a reactive form library to enhance interactivity and responsiveness. The pipeline may also be capable of generating single-page applications for multi-form workflow presentations. These applications may leverage a platform that supports routing and reactive forms, allowing for complex form workflows to be presented as a cohesive user experience. In some cases, the pipeline may support an open-ended set of target form presentations. This flexibility may allow developers to create custom form presentations tailored to specific platforms or use cases. The pipeline may also provide mechanisms for translating form functions into function scripts in the target form presentations, enabling complex form logic to be preserved across different presentation formats. The extensible nature of the pipeline may allow for the addition of new form generation capabilities over time. This approach may enable the programming language to adapt to evolving form presentation requirements and technologies without requiring fundamental changes to the core language structure.

The programming language may include an architecture for defining and executing workflows, including form actions and form flows. This architecture may provide a framework for evaluating form responses and triggering custom actions based on evaluation results. The architecture may utilize reusable components of the programming language to interpret questions, forms, and functions. These components may include parsers and abstract syntax trees for efficiently processing and manipulating form-related data. The architecture may incorporate a workflow lexer and parser to encode and decode workflow representations. These representations may include definitions for form actions and form flows, allowing for the creation of complex, interactive form experiences.

Form actions may be defined within this architecture to specify custom actions on single forms. These actions may include, but are not limited to, displaying messages, sending notifications, or triggering external events. The architecture may include components for executing the defined workflows. In some implementations, the architecture may receive form responses as input, store these responses, evaluate them based on the defined workflows, and generate appropriate feedback or actions. A form function engine may be incorporated into the architecture to execute user-defined form functions. This engine may interpret and run custom functions that perform complex calculations or data manipulations based on form responses.

The architecture may also include a workflow engine specifically designed to execute the form actions and form flows defined within the system. This engine may interpret workflow definitions and manage the progression through multi-form tasks or the triggering of specific actions based on form responses. In some cases, the architecture may utilize an event bus to coordinate the various function units within the system. This event bus may enable communication and synchronization between different components, allowing for efficient execution of workflows and actions. For example, when a form is submitted, the event bus may trigger the following sequence:
1. Store the form responses;
2. Execute any relevant form functions;
3. Evaluate the responses against defined form actions;
4. Trigger appropriate actions based on the evaluation results;
5. Determine the next step in the form flow, if applicable.

This coordinated approach may allow for complex, dynamic form behaviors while maintaining a modular and extensible architecture.

The architecture for defining and executing workflows may provide a powerful foundation for creating sophisticated form applications. By separating the definition of workflows from their execution, the system may offer flexibility for developers to create custom form experiences while leveraging a standardized execution environment.

The programming language may include an architecture for publishing workflows, including mechanisms for composing forms, form actions, and form audiences into publishable forms. This architecture may provide a structured approach to preparing and distributing forms for use by various user groups.

In some cases, the architecture may include a pipeline for composing forms, form actions, and form audiences into publishable forms. This pipeline may take individual components and combine them into a cohesive, ready-to-use form package.

In some implementations, the architecture may divide form audiences into specific groups of users. These groups may include, but are not limited to, visitors, authenticated users, and public users. This categorization may enable targeted publishing of forms and form flows.

The architecture may include a test unit to test and verify the functionality of publishable forms and publishable form flows before publishing. This test unit may help ensure the quality and correctness of the published workflows.

The test unit may perform various checks, such as validating form logic, ensuring all required fields are present, and verifying that conditional branching works as expected. In some cases, the test unit may also simulate user interactions to ensure the form behaves correctly under different input scenarios.

By incorporating these components, the architecture for publishing workflows may provide a comprehensive system for preparing, testing, and distributing forms and form flows to specific user groups. This approach may help ensure that published forms are of high quality and appropriately targeted to their intended audiences.

The programming language for building rich form applications integrates various modules and components to create a comprehensive system for form design and application development. This integration may promote portability, reusability, and community collaboration across different vendors and applications.

In some cases, the question definition module, form definition module, data flow module, and function definition module may work together to provide a complete representation of a form and its associated logic. The question definition module may define individual questions, which may then be referenced and organized within the form definition module. The data flow module may specify how these questions interact and change based on user input, while the function definition module may provide complex calculations and automated tasks based on form responses.

The reusable components, including lexers and parsers for questions, forms, data flows, and functions, may operate on the representations created by these modules. These components may facilitate the serialization, deserialization, and manipulation of form-related data, enabling efficient processing and storage of forms across different systems and applications.

In some implementations, the translator-based pipeline may utilize the parsed representations generated by the reusable components to produce target form presentations. This pipeline may allow for the creation of various form types, such as inline forms, web forms, and single-page applications, from a single portable form representation. This approach may promote form portability by enabling the same form definition to be rendered across different platforms and presentation formats.

The workflow definition and execution architecture may integrate with the other components to provide a system for evaluating form responses and triggering actions based on those responses. This architecture may utilize the function engine to execute custom calculations and the workflow engine to manage form actions and flows. The event bus within this architecture may facilitate communication between different components, enabling coordinated execution of complex form behaviors.

In some cases, the publishing architecture may build upon the other components to create a system for composing, testing, and distributing forms and form flows. This architecture may combine form definitions, actions, and audience specifications to create publishable forms that can be targeted to specific user groups.

The integration of these components may promote reusability by providing a set of standardized, modular building blocks for form application development. Developers may be able to leverage these components to create custom form applications without needing to implement low-level parsing, representation, or execution logic.

In some implementations, the portable nature of the form representations and the standardized components may facilitate community collaboration. Developers from different organizations or working on different applications may be able to share form definitions, custom functions, or workflow patterns. This sharing may be possible due to the common language and structure provided by the programming language.

The modular design of the programming language may allow for extensibility and customization. In some cases, developers may be able to add new question types, form presentation formats, or workflow actions by extending the existing components rather than modifying the core language structure.

By integrating these various components, the programming language may provide a comprehensive system for form design and application development that promotes portability, reusability, and community collaboration. This integrated approach may enable the creation of sophisticated, dynamic form applications while maintaining flexibility and interoperability across different platforms and use cases.

One embodiment of the invention lies in a hybrid programming language for defining the questions, the forms, the form data flow logic, and the form response evaluation logic. The programming language serves as a common ground for representing a form in a portable manner such that different form solution providers and different form applications can inter-operate on a single form. This portability will foster and grow the form applications in different aspects, including, but not limited to, the form analysis, form optimization, form translators, form response evaluation, and form response analytics and report.

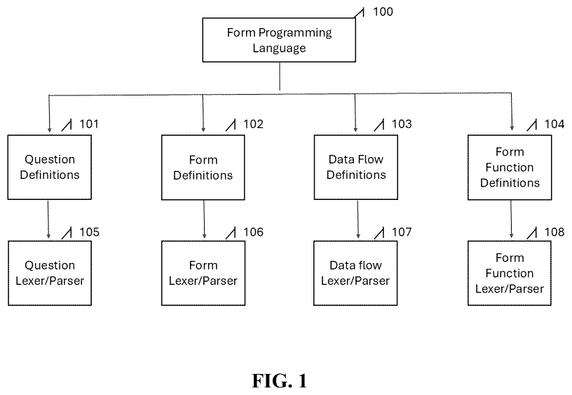

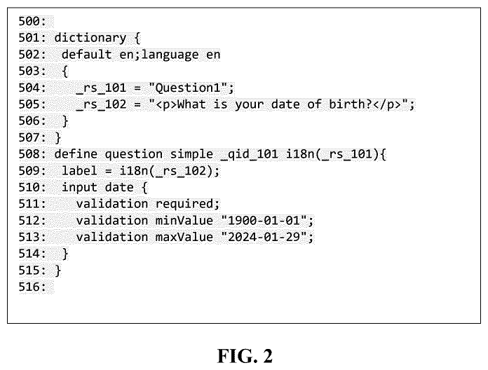

In FIG. 1 there is shown the structure of the language 100; it consists of four modules: the question module 101, the form module 102, the data flow logic module 103, and the form function module 104. Corresponding to the four modules, there are respectively four functional components for the language: the question lexer & parser 105, the form lexer &parser 106, the data flow lexer & parser 107, and the form function lexer & parser 108.
a. The lexer takes input as a string and converts the input into a set of tokens. The Parser which takes the tokens from the lexer and returns a syntax tree based on a grammar.
b. The grammar is often expressed in a meta language.

These lexer & parser components are the building blocks for the various form applications, described herein. The four modules in the language are independent, each with its own evolution path. In addition, the language is extensional with regard to new functional modules.

In another embodiment, the programming language includes a module for defining the various types of questions. In one case, a question requires a single input, and such a question is called a simple question, to be distinguishable from the compound one, to be described in the following.
a. The input type of a simple question may be one of the type attributes of the input element in HTML, such as text, email, password, number, URL, data, week, time, checkbox, radio button, and etc. The input type may also correspond to the one for the select element or the one for the text area element in the HTML.
b. Custom or future input types may fit in the language in a straightforward way as the language is extensible regarding the types of questions it can support.

The definition of a question includes the specification of the various attributes of the question, including, but not limited to, its name, title (label), default value, validation rules, and option values. The default value of a question states that the input value of the question is initialized to be the given default one. The validation rules on a question specify what input data is valid for the question. Specifically, the required validation rule of a question states that this question is mandatory; the respondent is required to provide an input to this question. The min/max validation rules of a question state that the input to this question must satisfy the min/max requirement. The pattern validation rule on a question requires that the input to the question conforms to the specified regular pattern. The option value attribute on a question describes the option values for the question whose type corresponds to the select control or the radio button in HTML. The option values can be pre-defined, as part of the question definition. The options attribute may also be an API endpoint, specified by a valid URL and a possible authentication mechanism, e.g., a basic authentication.

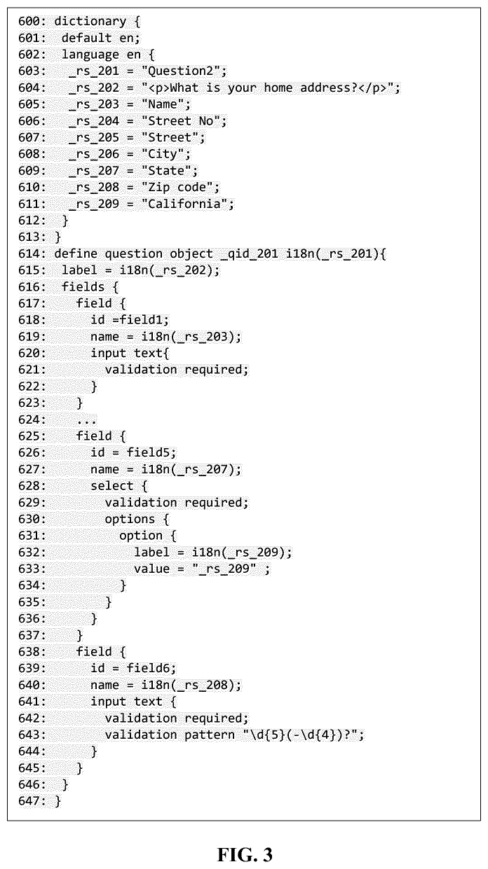

In FIG. 2 there is shown the question module of the programming language in the present invention. The code snippet corresponds to the definition of the question: “What is your date of birth?”. Line 501-507 describes the resource strings referred in the question definition; these resources strings are extracted into a dictionary body for flexible management of the textual contents in the whole language. The “define question” keywords at Line 508 mark the beginning of the question definition. The definition states that the question is a simple one; that its global unique identifier is “_qid_101”; that its name is the internationalized string of “_rs_101”; that its label is the internationalized string of “_rs_102”; its type is date; and it has three validation rules: required, the “1900-01-1” as its minimal value, and the “2024-01-29” as its maximal value.

In another example, a question may require more than one single input value from the respondent, and such a question is a compound question, which is supported by the question module of the programming language. One kind of the compound questions is a group question, composing of a set of simple questions; a group question corresponds to a high-level entity in the world, such as an address card including the street number, street name, city, and so on. A group question resembles the object in a general programming language like C++ or Java; it allows for composing the simple questions into the more complicated ones in an object-oriented way. Another kind of the compound questions is a table question, consisting of a set of simple questions as well but expecting a varied number of records as inputs. A table question resembles an array in the general programming language; it is the building block for a form to collect a varied number of records for a group of the simple questions.

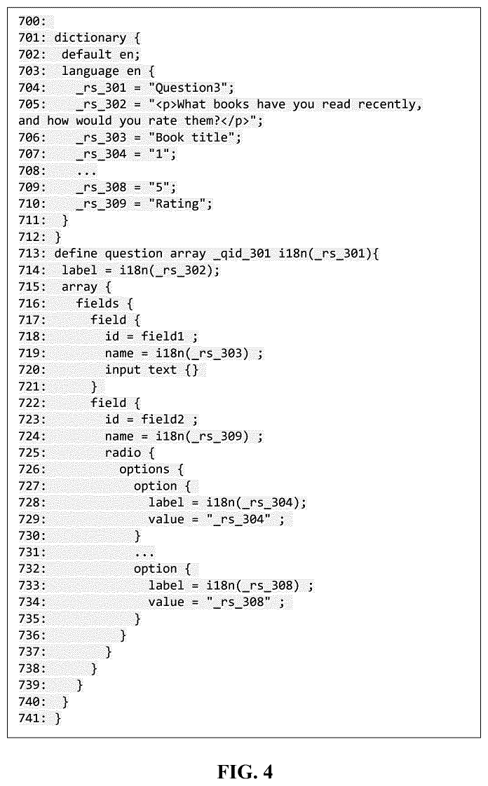

In FIG. 3 there is shown a group question defined in the programming language of the present embodiment. The question is “What is your home address?”; it is about an address, which includes the full name of the individual/organization associated with the address, the number on the street where the address is located, the name of the address, the city and the state where the address resides, and the postal code assigned to the address. Lines 600-613 defines the resource strings referred in the question definition. The question definition begins at line 614 with the keywords “define question”, followed by the question type “object” denoting a group question, followed by the question's globally unique identifier and its internationalized name. The following open brace marks the body of the question definition, which consists of the statement for the label of the question and the specification for the fields included in the question. The definition of a field resembles the definition of a simple question; it specifies the attributes on the field, including the label (name) of the field, the input type of the field, and the validation rules on the input to the field. The following field definitions describe the components of an address. Lines 617-623 is the definition for the name field, denoting the name of individual/organization associated with an address; the name field is a text input and it is required. Lines 625-636 is the definition for the state field, corresponding to the state in an address; different from the name field, the state field is a select control, including one pre-defined option. Lines 638-645 is for the zip code field; this field is also a text input but its input requires a pattern. FIG. 3 illustrates a simplified version of the group question. Some parts of the full definition have been omitted.

In FIG. 4 there is shown a table question defined in the programming language of the present invention. The question is “What books have you read recently, and how would you rate them?”; it requires two pieces of information for each book, the title of a book and the rating for it; moreover, a respondent to this question can provide more one book. Again Lines 701-712 denotes the resource strings referred in the table question definition. Line 713 marks the beginning of the question definition; the keyword array denotes that the question is a table question. Similar to the group question, the table question includes the specifications for a set of fields. Each field represents a column head in a table. Lines 717-721 defines the column for the book title; the input type of the column is text. Lines 722-738 denotes the column for the rating on a book; it is a radio button, providing 5 options from 1 to 5.

In another embodiment, the programming language includes a module for declaring the questions and defining the forms. As a variable declaration in a general programming language, like C++ or Java, is a statement that introduces a variable to a program, a question declaration is an introduction of a defined question into a form or another entity which uses this question. The definition of a form is composed of the form's various attributes, including its identifier, its description (which may be internationalized), the pairs of key-value properties associated with it, the pairs of key-value styles associated with it, and the presentation layout of the form. The layout specification of a form states the hierarchy structure of the form in terms of the abstract user interface elements, such as grid, flexbox, row, column, and cell. The grid or flexbox element is typically the top-level container element, and is typically related with the layout algorithm. The row and column elements are intermediate user interface elements. The cell element contains the leaf element or the nested top-level element. A leaf node may be a question label/input, a field label/input of a group question, a table element, the child element of a table, or a column label/input in a table. The layout specification is the input to a form translator, which transforms the high-level layout specification into one concrete representation, e.g., in HTML. More sophisticated layout algorithm can be provided based on the customer's needs.

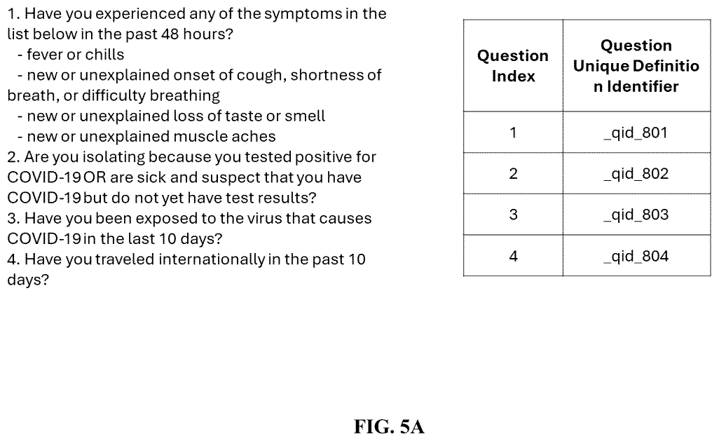

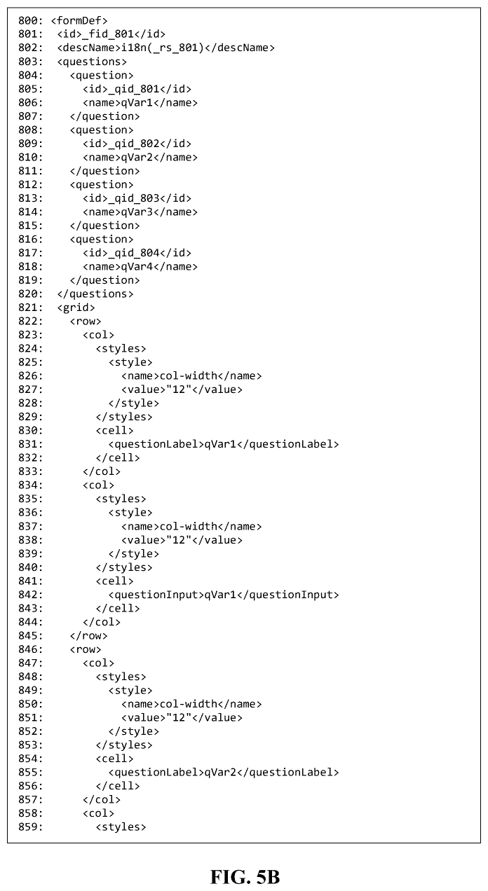

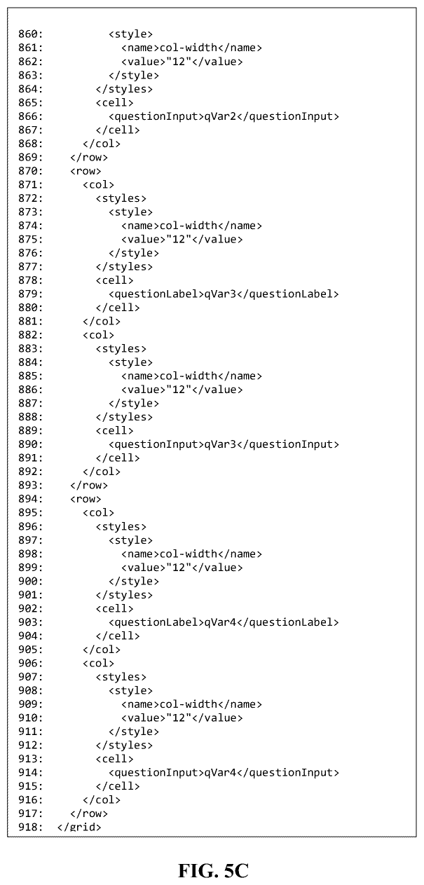

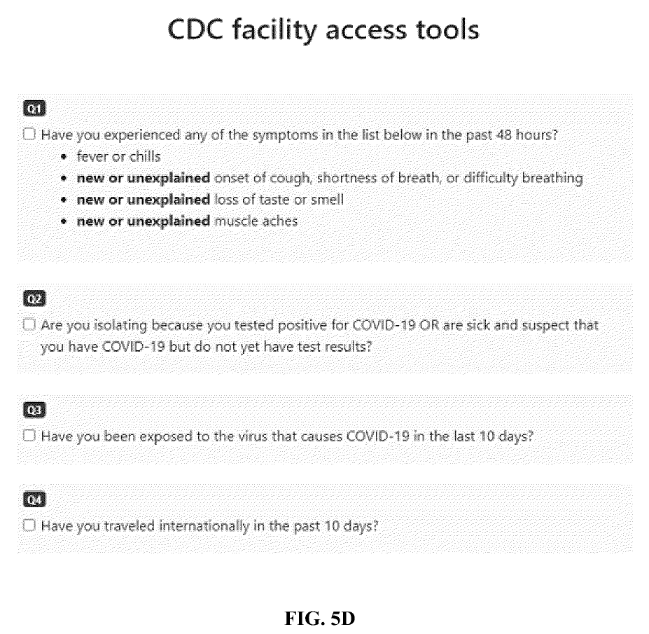

FIGS. 5A-5D there is shown a form created using the programming language in the present invention. This form contains 4 questions, depicted in FIG. 5A. The table lists each question's index and it's corresponding globally unique definition identifier. These identifiers will be used for reference in the following form definition. The XML specification in FIGS. 5B-5C is the definition of the form, enclosed inside the opening tag <formDef> at Line 800 and the closing tag </formDef> at Line 919. Line 801 is the statement for the unique identifier of the form, and Line 802 for the internationalized description name of the form. Lines 803-820 declare the questions included in the form; the declaration for each question consists of the unique identifier of the question and the local variable identifier of the question. Lines 821-918 are the layout specification of the form; the grid element indicates the rendering algorithm for its containing elements. A concrete implementation for the grid algorithm can be the mainstreaming responsive grid layout in the HTML Bootstrap framework, though other implementations are possible as well. The grid element contains many row elements, while each row is composed of many col elements. Each col element in turn contains a set of style attributes and a cell element, which encapsulates the label of a question, the input control of a question, or some other element. Lines 822-845 specifies the row for rendering the first question; Lines 823-833 states that the label of the question spans 12 columns in the grid framework and Lines 834-844 states that the input control of the question also spans 12 columns in the grid framework. FIG. 5D. displays a possible result which a form translator, to be described later, may produce based on the layout specification of the form.

In another embodiment, the language includes a module for defining the data flow logic on forms. The data flow on a form describes the state chart for the form at run time when the form is receiving the inputs from the respondent. One state of a form is determined by the input values to the questions of the form and the states of these questions, while a question state includes whether the question is visible on the form and whether it is disabled for receiving the focus and the input from the respondent on a device. The state chart specification is composed of a number of rules. One kind of rules describe the initialized values for the inputs to the questions. Another kind of rules, which are more typical in the data flow of a form, describes a pair of pre-state and post-state. I.e., when the pre-state happens, the post-state will follow. A method of detecting the cycle of state changes should be in place.

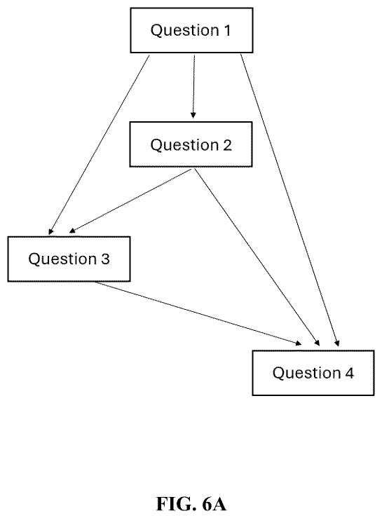

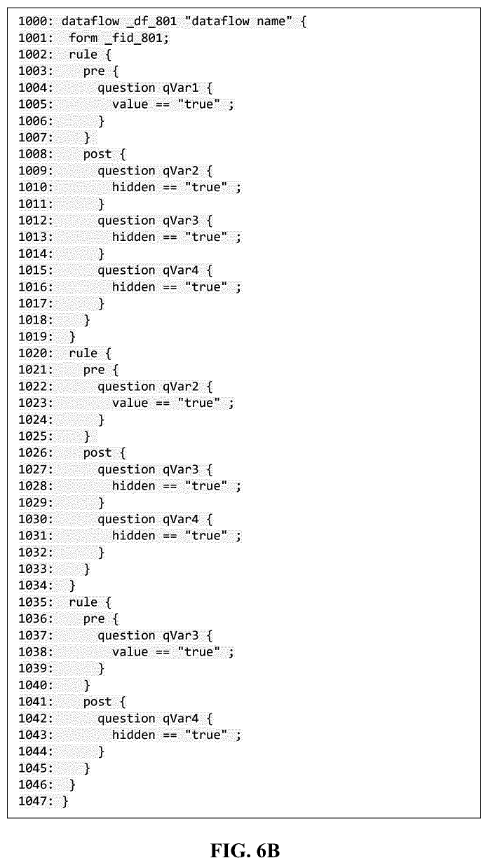

In FIGS. 6A-6B there is shown the data flow module of the programming language in the present embodiment. The data flow definition is concerned with the form in FIG. 5. FIG. 6A depicts the dependency among the four questions in the form. The dependency implies three rules: if the value of Question 1 is true, then the states of the other three questions become hidden (Rule 1); if the value of Question 2 is true, then the states of Question 3-4 become hidden (Rule 2); and if the value of Question 3 is true, then the state of Question 4 is hidden (Rule 3).

In FIG. 6B, the three rules are expressed. Line 1000 starts the data flow definition with the keyword dataflow, followed by the unique identifier “_df_801” and then by the name of the data flow definition. Lines 1001-1046 is the body of the definition, containing the declaration for the associated form and a set of rules. Each rule is composed of a pre block and a post block. Lines 1002-1019 corresponds to the definition for Rule 1. Lines 1003-1007 states the pre-conditions for the rule; Lines 1008-1018 specifies that the post-states of Question 2-4. Lines 1020-1034 is for Rule 2 and Lines 1035-1046 is for Rule 3.

In another embodiment, the language provides a module for defining form functions. A form function is side-effect free and may operate on a function or a question. In one case, a function takes an input value from a question and produces a value as its output. This output value can be a logic value, a number, a string, or a compound value like a JSON object. In another case, a function takes the inputs from all questions on a form and produces a value as its output. A function can involve the use of another function, as long as the computation at runtime terminates, enabling complex calculations and logic.

One embodiment of form functions utilizes a Scheme-like language. Syntactically, a top-level program in this language includes a sequence of expressions. Each expression is an atom, a list expression, or a quoted expression. An atom represents a logic value, a single character, a symbol, a string, or a number. A list expression is another expression enclosed in a pair of parentheses. A quoted expression starts with a single quote, followed by an expression. This Scheme-like language is expressive enough for various computations required at runtime. It is also extensible, allowing for an open-ended set of built-in functions provided in its core and a library.

This Scheme-like language, used for form functions, provides several advantages. Its functional nature, with side-effect-free functions, ensures predictability and simplifies debugging. Its expressiveness allows for a wide range of computations and logic definitions within forms. Its extensibility enables customization and adaptation to various use cases. The use of a Scheme-like syntax offers familiarity and ease of use for developers already acquainted with Lisp-style languages.

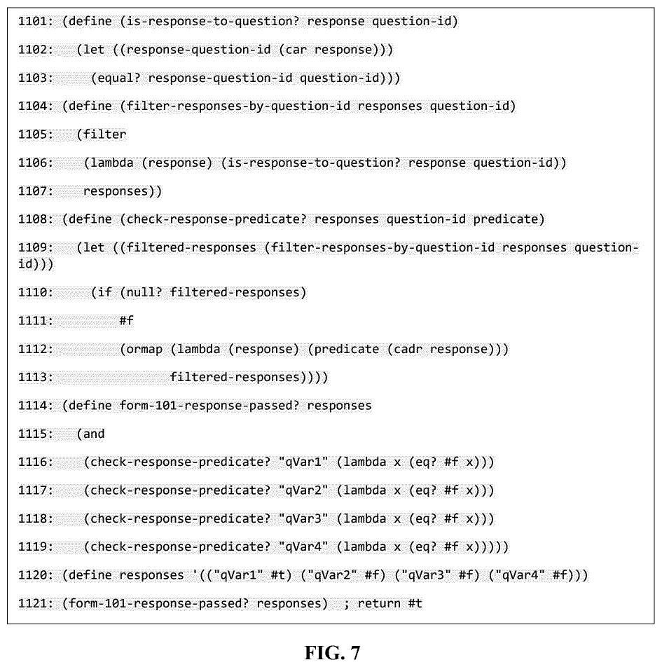

In FIG. 7 there is shown the form function module of the programming language in the present invention. The code in the figure, using a Scheme-like syntax, defines several functions that operate on form responses. The form-101-response-passed? function Lines 1114-1119 is a user-defined function that evaluates a form response. In this example, the form is a screening checklist, and the function aims to check if the answers to all questions on the form are false, thus determining if a respondent passes the screening. The naming convention for this function is as follows:
a. It starts with “form-” to denote it as a form-level function.
b. The number “101” is a unique identifier for the form, used for illustration.
c. “response-passed” is a system-generated or user-provided part indicating the function's purpose.
d. The question mark at the end signifies that the function is a predicate, returning a true or false value.

Lines 1120-1121 demonstrate the use of the form-101-response-passed? function with a sample response data set. The other functions defined in the code (is-response-to-question?, filter-responses-by-question-id, and check-response-predicate?) are reusable helper functions used in the form-101-response-passed? function. These helper functions showcase the modularity and reusability of form functions, enabling developers to create complex evaluation logic by combining simpler functions.

The programming language in the present embodiment lays the foundation for rich form applications across the software platforms and hardware devices, including, but not limited to, the question & form design, the form persistence, the form interpreter/compiler, the form analysis & optimization, the form response evaluation, the multi-form workflow, the form translator, the form publication, and the form response analytics and report. The programming language is composed of a number of modules. Each module has its own distinct programming patterns to address one aspect of the requirements for rich form applications. Though these modules are included in one programming language, they are loosely coupled in theory. Each module can be independently implemented and used. For example, a form designer may exploit only the question module of the language to provide the functions of defining questions; the resulting questions are stored in the non-volatile memory, e.g., on the desktop. The stored questions can be loaded, parsed, and interpreted by another form application on the mobile device.

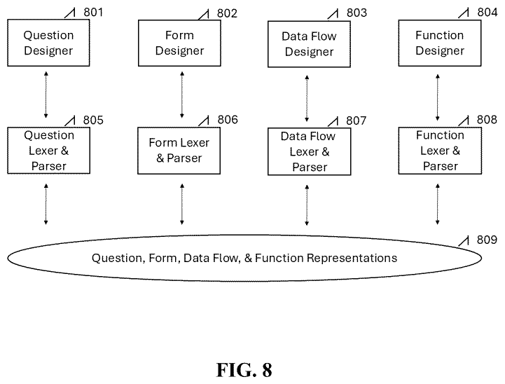

Rich form applications of the language are outlined in FIGS. 8 through 15.

Based on the programming language in the present embodiment, an exemplary form design system is shown in FIG. 8. The form design system consists of three independent function blocks: the question designer 801, form designer 802, data flow designer 803, and form function designer 804. These designers provide the user-friendly interfaces for the user to define the questions, the forms, the form's data flows, and the form functions. The user-friendly interfaces are typically accessible from a web application, a mobile application, and/or a desktop application. They guide the user to provide the information that is required by the programming language. Then the information is encoded as the question, form, data flow, & function representations 809. In the middle of the figure are the question lexer & parser 805, form lexer & parser 806, data flow lexer & parser 807, and function lexer & parser 808. These lexer & parsers serve as the modular, reliable function blocks that understand, interpret, and verify the representations of the questions, forms, data flows, and functions. Not only the designers in the FIG. 801-804 depend on them, but they are the indispensable building blocks for other form applications.

In FIG. 9 there is described an exemplary form translator system, which takes as input the representations of the questions, forms, data flows, and functions 910 and produces as output the various target form presentation applications 906-909. These target applications represent forms and their behaviors and are accessible to the user. In the figure, three specific types of translators 902-904 rely on the lexer & parsers 901, as explained previously. The inline HTML translator 902 produces the inline forms 906 that can be embedded in the third-party applications, such as Email. The AngularJS translator 903 produces a self-contained web page 907 built upon the AngularJS platform; the resulting web page contains the AngularJS-powered reactive forms. The Angular 2.x translator 904 generates a single page application (SPA) 908, which leverages the Angular 2.x platform; the SPA contains one or more reactive forms. The form translator system is extensible and can support many other translators 905, as required by other applications 909. These applications include but, not limited to, the interactive PDF documents and the form-specific desktop applications. All of the target applications 906-909 may include function scripts 911, which are translated from form functions and accessible at runtime in the target applications.

The form functions of the programming language in the present invention enables automating the various form tasks. Specifically, combining it with the workflow specification lays a base for automating form response evaluation and further streamlining the multi-form tasks.

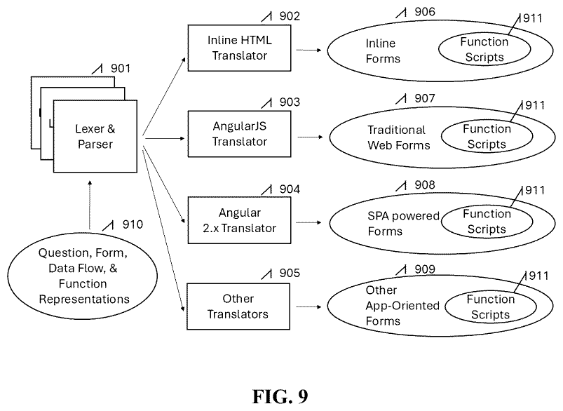

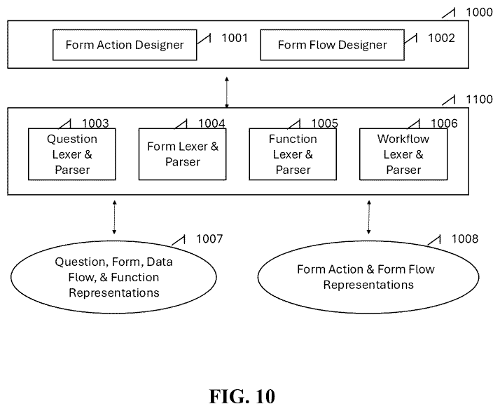

In FIG. 10 there is shown an exemplary system for defining the automation tasks for the forms. The form action designer 1001 provides the user interface for defining the tasks on a single form. A typical form task is evaluating the form response and then sending out different feedbacks to the respondents based on the evaluation results. Take the form in FIG. 5 as an example, a respondent will receive passing feedback if this respondent does not check any question in the form; otherwise, a respondent will receive non-passing feedback. The form flow designer 1002 allows the user to compose multiple forms into a single, unified experience for the respondents. Multiple forms can be sequentially or conditionally connected; a respondent is guided towards different forms based on the respondent's responses. Both of the two designers depend on the four function blocks 1003-1006 in the figure. The question lexer & parser 1003, form lexer & parser 1004, function lexer & parser 1005, depending on question, form, data flow, and function representations 1007 are as described earlier. The workflow lexer & parser 1006 is the function unit that understands, interprets, and verifies the task representations for one or multiple forms. The form action & flow representations 1008 encode the workflow specifications, including the use of form functions for the form actions & flows.

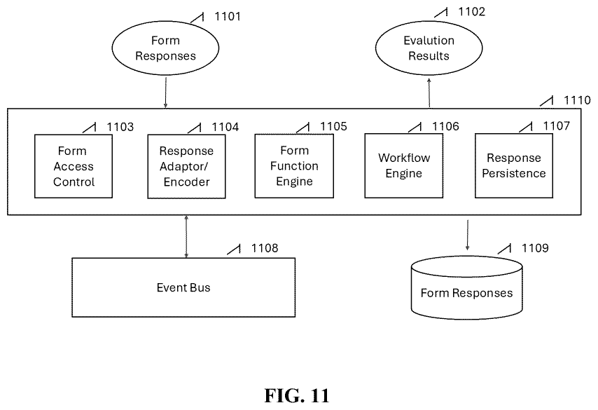

In FIG. 11 there is shown an exemplary system that automatically evaluates the form responses based on the form automation tasks, e.g., defined by the form action and flow designer described above. When the form responses 1101 arrive, the access control 1103 safeguards the access to the system, e.g., ensuring authorized requests, protecting data security, and establishing audition records. The response adapter/encoder 1104 transforms/encodes the incoming responses into their internal structures which are suitable for further processing in the system. The form function engine 1105 and workflow engine 1106 apply the pre-defined workflows, including the referenced form functions, to the form responses. Then the system sends out the evaluation results 1102 to the respondents. The response persistence unit 1107 is responsible for storing the form responses and the associated evaluation results into the non-volatile memory, such as the database 1109. The event bus 1108 provides the communication facility for the other function units, including event publication and subscription and event routing.

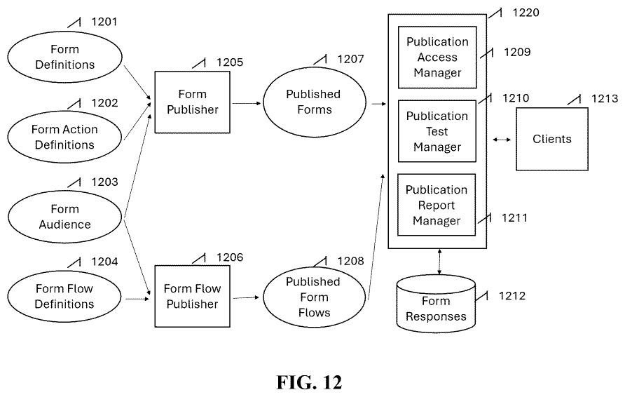

In FIG. 12 there is shown an exemplary form publication system. It includes two publishers. The form publisher 1205 focuses on the publications for single forms; it guides the user to choose a form 1201, optionally select a form action 1202, which will be executed on the responses of the form, and select the target audiences 1203 for the form. Different types of target audiences require different access control methods. For example, a registered audience may go through the mainstream authentication and authorization flow, e.g., by providing a pair of user name and password; a guest may be asked for a password; a regular visitor may be asked for the verification information to get authenticated and authorized. The form flow publisher 1206 guides the user to select a form flow 1204 and choose the target audiences 1203. The published forms 1207 and form flows 1208 are the software artifacts that will be accessed by the form respondents; the publication access manager 1209 manages the request to access them from the client 1213. The published artifacts may receive tests to verify their behavior; the test functionality is provided by the publication test manager 1210. In addition, the publication report manager 1211 generates the various analysis reports on the form responses. The publication access, test, and report managers depend on the functional units described in FIG. 11. Finally, the form responses 1212 are stored in the non-volatile memory, as the processing result and for the future use.

Form publication can be a routine job in many scenarios. For example, a new round of screening questions is required every day in an organization; in this case, typically a new publication is created every day. The form routine tasks such as the daily publication job can be automated.

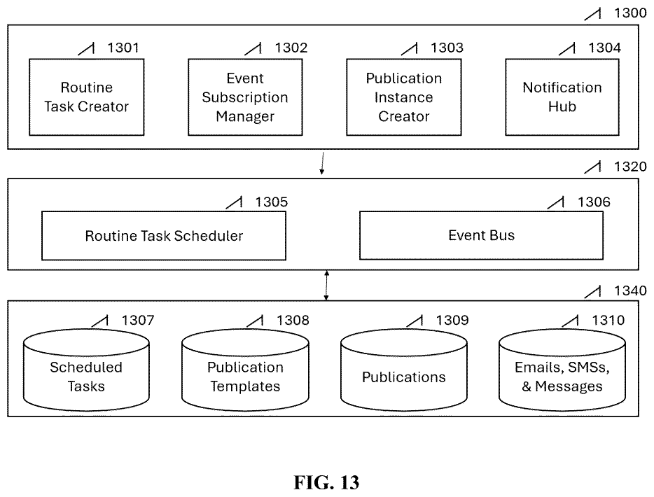

In FIG. 13 there is shown an exemplary automation system for managing and automating form routine tasks. The background task creator 1301 provides the user interface for creating routine tasks; the event subscription manager 1302 allows the user to set up the actions for the various events associated with the form routine tasks. The scheduled tasks 1307 and the publication templates 1308, as the products of the task creator 1301, are persisted into the non-volatile memory. The routine task scheduler 1305 polls all of the scheduled tasks and creates their instances on time. The publication instance creator 1303 instantiates the form publication templates into concrete form publications 1309, stored into the non-volatile memory. Along with the instantiating process, various events are raised. The event bus 1306 acts as the communication channel among the function blocks in the system. The notification hub 1304 responds to the raised events and sends to the user the various notifications, such as emails, SMSs (short message service), and private messages.

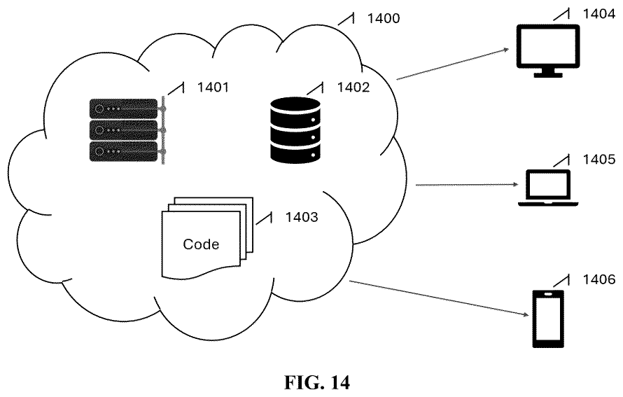

In FIG. 14 there is shown a cloud computing environment that is suitable for hosting the service characterized with the functions and features in the present invention. Cloud computing represents a paradigm shift in the delivery and consumption of information technology (IT) resources. Instead of owning and managing physical hardware and software in on-premises datacenters, cloud computing enables on-demand access to a shared pool of configurable computing resources over a network (commonly the Internet). These resources include servers, storage, networking components, databases, analytics tools, and development platforms. Key characteristics of cloud computing include:
a. On-Demand Self-Service: Provisioning and de-provisioning of resources can occur rapidly and autonomously by users, without requiring interaction with service providers.
b. Broad Network Access: Cloud resources are made available over standard network protocols, supporting access from diverse client devices (e.g., laptops, tablets, smartphones).
c. Resource Pooling: Provider resources are dynamically allocated and reallocated in a multi-tenant model, providing location independence and economies of scale.
d. Rapid Elasticity: Computing capabilities can be flexibly scaled up or down to match workload demands, often in an automated fashion.
e. Measured Service: Cloud usage is automatically monitored, providing transparency for both provider and consumer, typically involving a pay-per-use billing model.

Additionally, there are three popular service models:
a. Infrastructure-as-a-Service (IaaS),
b. Platform-as-a-Service (PaaS), and
c. Software-as-a-Service (SaaS).

IaaS delivers fundamental compute, storage, and networking resources as virtualized services. Users retain control of operating systems, middleware, and applications. PaaS provides a managed environment for developing, deploying, and running applications. Users focus on application logic without managing the underlying infrastructure. Last, SaaS provides complete software applications delivered over the Internet. Users access the software through a web browser or thin client, relinquishing management of the underlying application stack. As shown in FIG. 14, the cloud 1400 encompasses the software and hardware resources for offering the service to the user, such as the computing server 1401, the database 1402, and the application code 1403. A user may access the service via the desktop computer 1404, the laptop 1405, and/or the mobile device 1406. The software stack of the form applications described in the present invention may be deployed in a cloud computing environment. The cloud computing environment provides the necessary hardware and platforms for running the form applications, including, but not limited to, the relational database such as the MS SQL and PostgreSQL, the NoSQL database such as MongoDB, the in-memory storage such as Redis, the message broker such as RabbitMQ, and the file system.

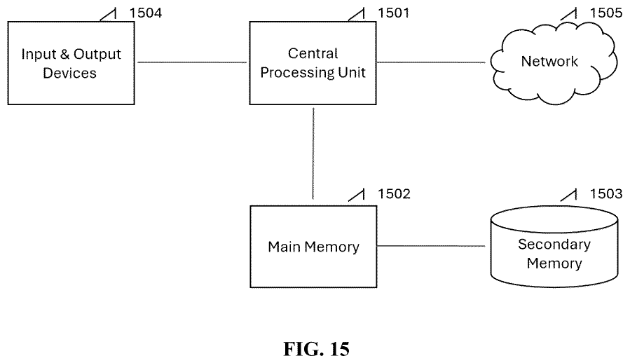

In FIG. 15 there is shown a general-purpose computer system designed to execute a wide range of software applications. The system comprises the following core components:
a. Central Processing Unit (CPU) 1501: The “brain” of the computer, responsible for executing instructions that comprise applications and manage system operations. The CPU fetches instructions from memory, decodes them, and performs the specified calculations or data manipulations.
b. Main Memory Unit (RAM) 1502: Random Access Memory (RAM) serves as the primary workspace for the CPU. It temporarily stores active applications, their associated data, and portions of the operating system essential for current tasks. RAM is characterized by fast access speeds but is volatile, meaning its contents are lost when power is removed.
c. Secondary Memory Unit(s) 1503: This category encompasses non-volatile storage devices such as hard disk drives (HDDs) and solid-state drives (SSDs). Secondary memory provides long-term storage for applications, data files, and the operating system itself, persisting even when the system is powered off.
d. Input/Output (I/O) Devices 1504: These facilitate interaction between the user and the computer system. Examples of the input devices include keyboards, mice, touchpads, microphones, cameras, and other sensors that allow users to enter data and commands. Examples of the output devices include displays, speakers, printers, and actuators that present information or carry out actions under the computer's control.
e. Network Interface 1505: This component, either wired (e.g., Ethernet) or wireless (e.g., Wi-Fi), enables the computer system to connect to other computers and devices over a network, most commonly the internet. Networking facilitates data exchange, remote application access, and distributed computing.

A computer system is where the form application can be executed. The form application, typically residing in secondary memory 1503, is loaded into main memory (RAM) 1502 either in its entirety or in portions as needed. Next, the CPU 1501 begins executing the application's instructions, fetching data from main memory, performing calculations, and manipulating data as directed by the application logic. The application might request additional data from secondary storage, process input from the user via input devices, or generate output presented on output devices. It may also leverage the network interface 1505 to communicate with remote systems, retrieve data from online sources, or participate in collaborative tasks.

One embodiment is directed to a programming language for building form applications. The programming language includes a question definition module providing an extensible object-oriented specification language for defining questions. The programming language includes a form definition module providing an extensible declarative specification language for defining forms, a data flow module providing a rule-based specification language for defining runtime state changes of forms and a function definition module providing a functional programming language for building calculations on form states and form responses. The question definition module may support defining simple questions requiring single inputs and compound questions expecting structured record inputs or multiple records. The compound questions may include object-like questions expecting structured record inputs and array-like questions accepting multiple records. The form definition module may support multi-language capabilities for text and labels within forms. The form definition module may use an XML-like layout specification for defining the structure and organization of forms. The data flow module may enable conditional branching, automatic value assignment, and input validation based on user responses. The function definition module may support first-class functions, higher-order functions, and recursion for implementing complex form logic and behaviors.

Another embodiment is directed to a method for generating portable form representations. The method includes receiving a form definition using an extensible declarative specification language, parsing the form definition to generate a form abstract syntax tree, and applying data flow rules to the form abstract syntax tree to define runtime state changes. The method includes generating a portable form representation including the form abstract syntax tree and associated data flow rules. The method may include receiving question definitions using an extensible object-oriented specification language and incorporating the question definitions into the form abstract syntax tree. The question definitions may include simple questions requiring single inputs and compound questions expecting structured record inputs or multiple records. The method may include applying function definitions to the form abstract syntax tree to enable complex calculations on form states and form responses. The function definitions may support first-class functions, higher-order functions, and recursion. The portable form representation may be independent of specific applications or vendors. The method may include generating a target form presentation from the portable form representation using a translator-based pipeline.

Another embodiment is directed to a system for executing form workflows. The system includes a form function engine configured to execute user-defined form functions and a workflow engine configured to execute form actions and form flows. The system includes an event bus configured to coordinate communication between the form function engine and the workflow engine. The form function engine may execute first-class functions, higher-order functions, and recursive functions. The workflow engine may execute form actions comprising displaying messages, sending notifications, and triggering external events. The workflow engine may execute form flows comprising conditional branching and redirection among multiple forms. The event bus may trigger a sequence of operations upon form submission, including storing form responses, executing relevant form functions, evaluating responses against defined form actions and determining a next step in a form flow. The system may include a test unit configured to verify functionality of publishable forms and form flows before publishing, wherein the test unit performs checks including validating form logic, ensuring presence of required fields, and simulating user interactions.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A programming language for building form applications, comprising:
a question definition module providing an extensible object-oriented specification language for defining questions;
a form definition module providing an extensible declarative specification language for defining forms;
a data flow module providing a rule-based specification language for defining runtime state changes of forms; and
a function definition module providing a functional programming language for building calculations on form states and form responses.

2. The programming language of claim 1, wherein the question definition module supports defining simple questions requiring single inputs and compound questions expecting structured record inputs or multiple records.

3. The programming language of claim 2, wherein the compound questions comprise object-like questions expecting structured record inputs and array-like questions accepting multiple records.

4. The programming language of claim 1, wherein the form definition module supports multi-language capabilities for text and labels within forms.

5. The programming language of claim 4, wherein the form definition module utilizes an XML-like layout specification for defining the structure and organization of forms.

6. The programming language of claim 1, wherein the data flow module enables conditional branching, automatic value assignment, and input validation based on user responses.

7. The programming language of claim 1, wherein the function definition module supports first-class functions, higher-order functions, and recursion for implementing complex form logic and behaviors.

8. A method for generating portable form representations, comprising:
receiving a form definition using an extensible declarative specification language;
parsing the form definition to generate a form abstract syntax tree;
applying data flow rules to the form abstract syntax tree to define runtime state changes;
applying form functions to the form abstract syntax tree to define calculations on form states and form responses; and
generating a portable form representation including the form abstract syntax tree and associated data flow rules and form functions.

9. The method of claim 8, further comprising:
receiving question definitions using an extensible object-oriented specification language; and
incorporating the question definitions into the form abstract syntax tree.

10. The method of claim 9, wherein the question definitions comprise simple questions requiring single inputs and compound questions expecting structured record inputs or multiple records.

11. The method of claim 8 including applying function definitions to the form abstract syntax tree to enable complex calculations on form states and form responses.

12. The method of claim 11, wherein the function definitions support first-class functions, higher-order functions, and recursion.

13. The method of claim 8, wherein the portable form representation is independent of specific applications or vendors.

14. The method of claim 13 including generating a target form presentation from the portable form representation using a translator-based pipeline.

15. A system for executing form workflows, comprising:
a form function engine configured to execute user-defined form functions;
a workflow engine configured to execute form actions and form flows; and
an event bus configured to coordinate communication between the form function engine and the workflow engine.

16. The system of claim 15, wherein the form function engine is configured to execute first-class functions, higher-order functions, and recursive functions.

17. The system of claim 15, wherein the workflow engine is configured to execute form actions comprising displaying messages, sending notifications, and triggering external events.

18. The system of claim 17, wherein the workflow engine is further configured to execute form flows comprising conditional branching and redirection among multiple forms.

19. The system of claim 15, wherein the event bus is configured to trigger a sequence of operations upon form submission, comprising:
storing form responses;
executing relevant form functions;
evaluating responses against defined form actions; and
determining a next step in a form flow.

20. The system of claim 15 including a test unit for verifying functionality of publishable forms and form flows before publishing, wherein the test unit performs checks including validating form logic, ensuring presence of required fields, and simulating user interactions.
